(19) United States
(12) Patent Application Publication
(10) Pub. No.: US 2019/0180179 A1
(43) Pub. Date: Jun. 13, 2019

(54) METHOD AND APPARATUS FOR DESIGNING A POWER DISTRIBUTION NETWORK USING MACHINE LEARNING TECHNIQUES

(71) Applicant: Intel Corporation, Santa Clara, CA (US)

(72) Inventor: Wendemagegnehu T. BEYENE, San Jose, CA (US)

(21) Appl. No.: 16/230,914

(22) Filed: Dec. 21, 2018

(51) Int. Cl. G06N 3/08; G06N 20/00

(52) U.S. Cl. CPC G06N 3/08; G06N 20/00

(57) ABSTRACT

A method for training an artificial neural network to design a power distribution network (PDN) for a system includes generating signal variation statistics of the system from PDN parameters input into the artificial neural network. The artificial neural network is modified such that the signal variation statistics of the system generated by the neural network match expected signal variation statistics of the system.

### FIELD

Embodiments of the present disclosure relate to power distribution networks (PDNs). More specifically, embodiments of the present disclosure relate to a method and apparatus for designing PDNs using machine learning techniques.

### BACKGROUND

A common technique used for designing PDNs involves determining a maximum impedance that will assure that voltage excursions on a power rail will be maintained within allowable limits. This maximum impedance is referred to as the target impedance. Target impedance of a PDN can be expressed with the following relationship.

|Z_{Target}(f)|=V_{SupplyRail}×% V_{Ripple}/I_{MaxTransientCurrent}

In this relationship V_{SupplyRail} is the supply voltage for a system and % Vᵣᵢₚₚₗₑ is the maximum amount of ripple voltage in the percentage of the supply voltage that the circuit can sustain and operate normally. I_{MaxTransientCurrent} is the maximum transient current the system tolerate during normal and reset operations. Using this technique, the goal for the design of the PDN is to have the impedance of the power distribution system be below the target impedance across all frequencies to be an acceptable design.

Achieving this goal can be challenging and may require a complex solution to reduce a peak impedance formed by the resonance of the package inductance and the on-chip capacitance formed in mid-frequency range. This impedance peak is often located in the frequency range of tens of megahertz to several hundred megahertz. This frequency range is critical for many applications where the current spectrum in the region cannot be assumed to be negligible. The mitigation often requires a large number of board and package decoupling capacitors with sufficient amount of on-die decoupling capacitance which can be costly.

As the supply voltage requirement for new systems is decreasing and the maximum transient current for the new systems is increasing, the desired target impedance is dropping dramatically to support the power distribution for the latest semiconductor products. For high-performance systems, the target impedance may be in the range of sub-milliohms. The fundamental reason that target impedance needs to be low over a wide frequency is that the spectrum content of the current of such high-performance systems is assumed to be unknown and therefore an assumption is made that it can have a strong spectrum at any frequency. Designing PDNs using the current technique based on target impedance is becoming more difficult even with the utilization of hundreds of board and package decoupling capacitors.

### BRIEF DESCRIPTION OF THE DRAWINGS

The features and advantages of embodiments of the present disclosure are illustrated by way of example and are not intended to limit the scope of the embodiments of the present disclosure to the particular embodiments shown.

FIG. 1 is a flow chart illustrating a method for designing a power distribution network using an artificial neural network according to an exemplary embodiment of the present disclosure.

FIG. 2 is an equivalent circuit model of a power distribution network according to an embodiment of the present disclosure.

FIGS. 3A-3C illustrate plots of an impedance of a power distribution network associated with a board, package, and die of a system according to an embodiment of the present disclosure.

FIG. 4 illustrates a voltage supplied to a power distribution network according to an exemplary embodiment of the present disclosure.

FIG. 5 illustrates on-die power distribution network current waveforms, and on die maximum power distribution network noise and jitter according to an exemplary embodiment of the present disclosure.

FIG. 6 is a flow chart illustrating a method for training an artificial neural network to design a power distribution network according to an exemplary embodiment of the present disclosure.

FIG. 7 illustrates an artificial neural network according to an exemplary embodiment of the present disclosure.

FIG. 8 illustrates a node in an artificial neural network according to an exemplary embodiment of the present disclosure.

FIG. 9 is a flow chart illustrating a method for modifying an artificial neural network according to an exemplary embodiment of the present disclosure.

FIG. 10 is a flow chart illustrating a method for designing a power distribution network using a trained artificial neural network according to an exemplary embodiment of the present disclosure.

FIG. 11 illustrates a block diagram of a computer system implementing an artificial neural network training unit and a power distribution network design unit according to an exemplary embodiment of the present disclosure.

FIG. 12 is a block diagram of an artificial neural network training unit according to an exemplary embodiment of the present disclosure.

FIG. 13 is a block diagram of a power distribution network design unit according to an exemplary embodiment of the present disclosure.

### DETAILED DESCRIPTION

In the following description, for purposes of explanation, specific nomenclature is set forth to provide a thorough understanding of embodiments of the present disclosure. It will be apparent to one skilled in the art that specific details in the description may not be required to practice the embodiments of the present disclosure. In other instances, well-known circuits, devices, procedures, and programs are shown in block diagram form to avoid obscuring embodiments of the present disclosure unnecessarily.

Embodiments of the present disclosure remove the fundamental barrier with the design of power distribution network (PDN) of semiconductor systems. Instead of using a target impedance over a wide frequency range to design the PDN, machine learning techniques are used to verify that a specific design of the power distribution network can support a set of current profiles expected in the operation of the system. This may be performed by training an artificial neural network and using the artificial neural network to capture all or the most critical current activities of components in the system, various voltage regulator module (VRM) supply voltages and tolerances that support them, as well as other PDN parameters.

An artificial neural network is a nonlinear network that can be used to solve complex problems with its nonlinear modeling and parallel processing capabilities, and its ability to learn and generalize. An artificial neural network can provide a robust representation of nonlinear mappings between design parameters, such as those associated with a board, packages, and dies (chips) of a system, component specifications, such as those associated with VRM tolerances of the system, and the desired performance of the system. Since the input and output relationships in an artificial neural network are expressed using simple functions, the artificial neural network may speed up its analysis without sacrificing accuracy. An artificial neural network can provide an improved method for determining the quality of a power distribution network design that takes into account the characteristics of board, packages, and chips as well as VRM power supply and tolerances.

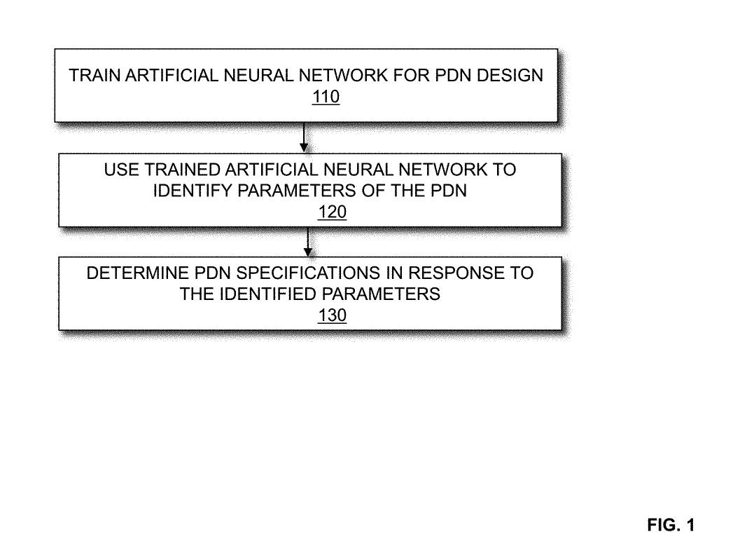

FIG. 1 is a flow chart illustrating a method for designing a power distribution network (PDN) using an artificial neural network according to an exemplary embodiment of the present disclosure. At 110, the artificial neural network is trained to perform PDN design. According to an embodiment of the present disclosure, a supervised training methodology is employed where the artificial neural network is evaluated and modified in response to desired or expected output values provided. In this embodiment, the relationship between the performance of a system and power distribution network parameters may be expressed with the following relationship.

Y=F(X)

In this relationship, F is the nonlinear mapping and X and Y are the n-dimensional input and m-dimensional output vectors that represent PDN parameters and the desired system performance, respectively. The inputs of the artificial neural network may include PDN parameters such as on-die PDN current waveforms (supply current waveforms), the impedance of the PDN which includes the impedance associated with a board, package, and die of the system, and the voltage supplied by the VRM of the system and DC and AC tolerances of the VRM. The output of the artificial neural network may include signal variance statistics that may include noise and/or jitter statistics such as on-die maximum PDN noise and/or on-die maximum jitter of the system. According to an embodiment of the present disclosure, noise may be defined as the unwanted voltage fluctuations that accompany an electric signal. Jitter may be defined as the deviation of a signal from the true periodicity of a presumably periodic signal. During training, the artificial neural network may be modified such that the noise and/or jitter statistics output from the artificial neural network matches or converges to desired or expected noise statistic values provided.

At 120, the trained artificial neural network is used for PDN design. According to an embodiment of the present disclosure, inputted PDN parameters for the PDN of a system are evaluated in response to the noise and/or jitter statistics output from the trained artificial neural network. The inputted PDN parameters may be iteratively modified during this design phase until the noise and/or jitter statistics output from the trained artificial neural network are acceptable. It should be appreciated that the PDN parameters provided by a user or designer during the design phase is a proper subset of the PDN parameters used by the artificial neural network during training

At 130, the identified PDN parameters associated with the acceptable noise and/or jitter statistics are used to further determine PDN specifications for the system. According to an embodiment of the present disclosure, procedure 120 identifies values for a voltage of a VRM of the system and DC and AC tolerances of the VRM, and a value for an impedance of the PDN associated with a board of the system that yields acceptable noise and/or jitter statistics. In this embodiment, resistive, inductive, and capacitive components that would support the VRM and the board of the system may be determined in response to the identified values.

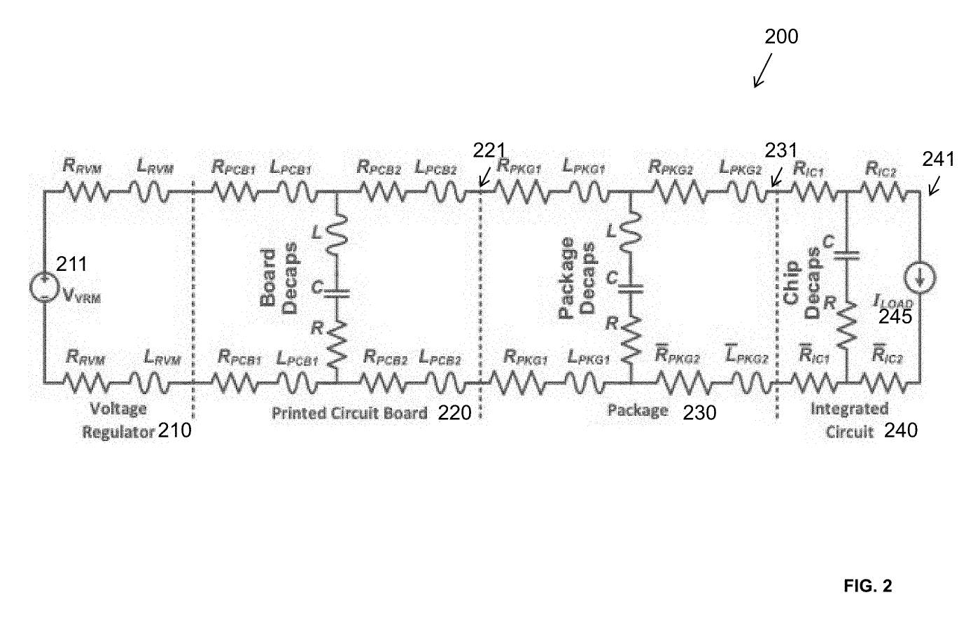

FIG. 2 illustrates an equivalent circuit model of a power distribution network (PDN) 200 of a system according to an exemplary embodiment of the present disclosure. The PDN 200 includes a voltage regulator 210 with a voltage regulator module (VRM) 211. The VRM 211 supplies a desired voltage, V_{supply} or V_{VRM}, to the system. The VRM 211 is connected to a printed circuit board 220 with multiple power planes and a large number of decoupling capacitors (“board decaps”). Package 230 and integrated circuit (die) 240 portions of the PDN 200 represent the packages and integrated circuits of components in the system which include decoupling capacitors. The components may include programmable logic devices, central processing units (CPUs), graphics processing units (GPUs), and/or other components. These components may have associated parasitic elements such as resistance, inductance, and capacitance.

According to an embodiment of the present disclosure, the design of a PDN involves optimizing the circuit elements in the equivalent circuit model of the PDN 200. Among the PDN parameters that can be used for designing a PDN for a system is the on-die power supply current, I(t), which can be measured at I_{LOAD} 245. Another PDN parameter that can be used for designing a PDN for a system is the impedance of the PDN, Z_{PDN}, which includes the impedance of the board, package, and integrated circuit. The impedance for the board, Z_{Brd}, can be measured at 221. The impedance for the board and package, Z_{Brd} and Zp_{Pkg}, can be measured at 231. The impedance for the board, package, and integrated circuit, Z_{Brd}, Z_{Pkg}, and Z_{Die}, can be measured at 241. Another PDN parameter that can be used for designing a PDN for a system is the voltage supplied by the VRM 211, V_{supply}, which can be measured at 211. The on-die maximum PDN noise and on-die maximum jitter are also important PDN parameters and both can also be measured at 241.

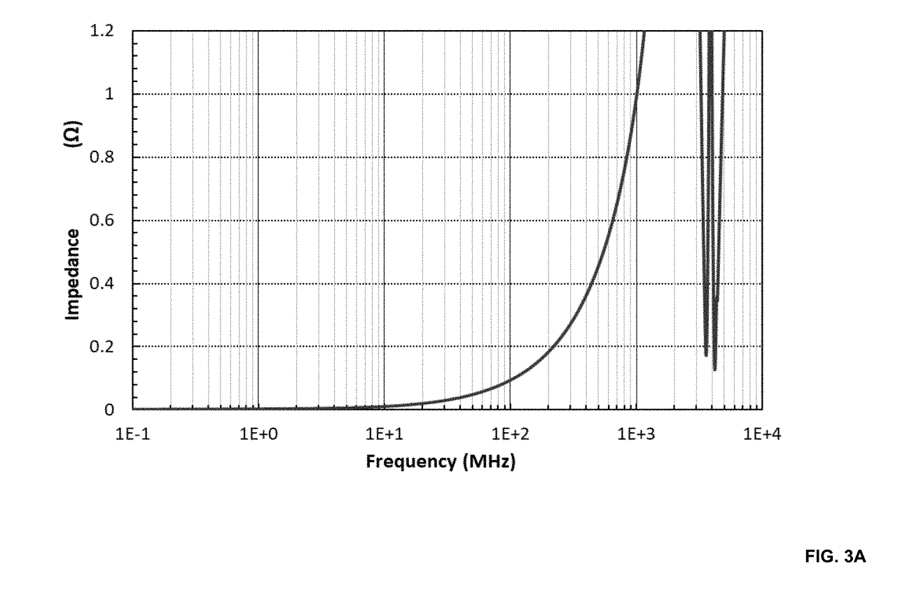

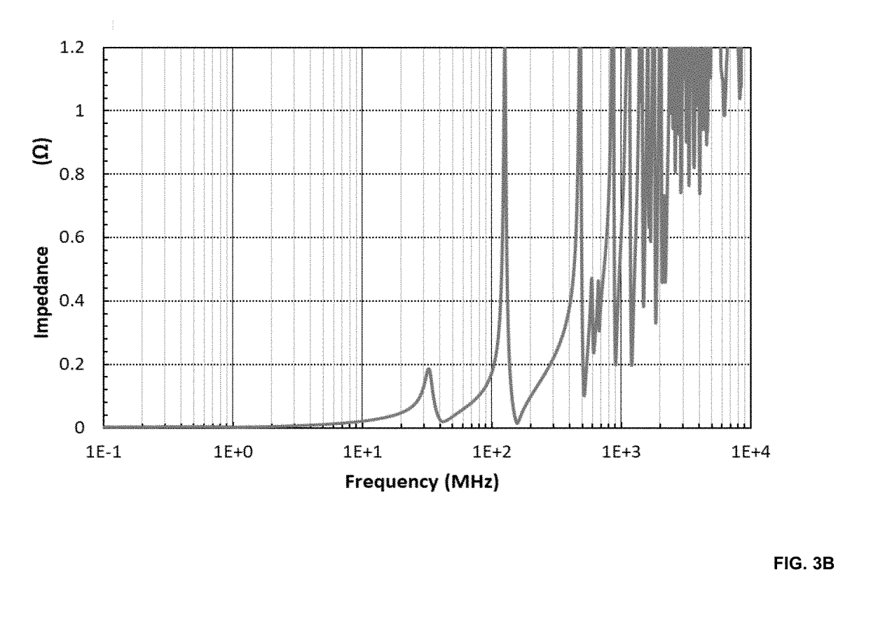

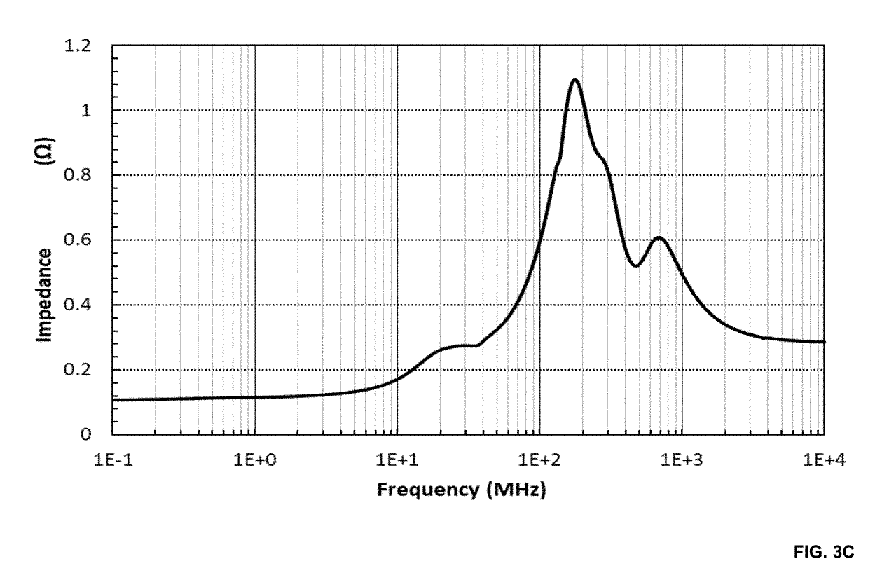

FIG. 3A illustrates a plot of an impedance of a power distribution network (PDN) associated with a board according to an embodiment of the present disclosure. FIG. 3B illustrates a plot of an impedance of a PDN associated with a package according to an embodiment of the present disclosure. FIG. 3C illustrates a plot of an impedance of a PDN associated with a board, package, and die of a system according to an embodiment of the present disclosure. The impedance of a PDN is a parameter that reflects the quality of a power supply network in board, package, and die. The impedance of a PDN is a direct function of the design of the PDN and the plane, interconnect, vias, and decoupling capacitors on the board, package, and die. The impedance of the PDN is a complex value and is shown in FIGS. 3A-3C with its magnitude plotted as a function of frequency. In the frequency domain, the impedance of the PDN may be computed by multiplying the impedance of the PDN associated with the board with the impedance of the PDN associated with the package with the impedance of the PDN associated with the die.

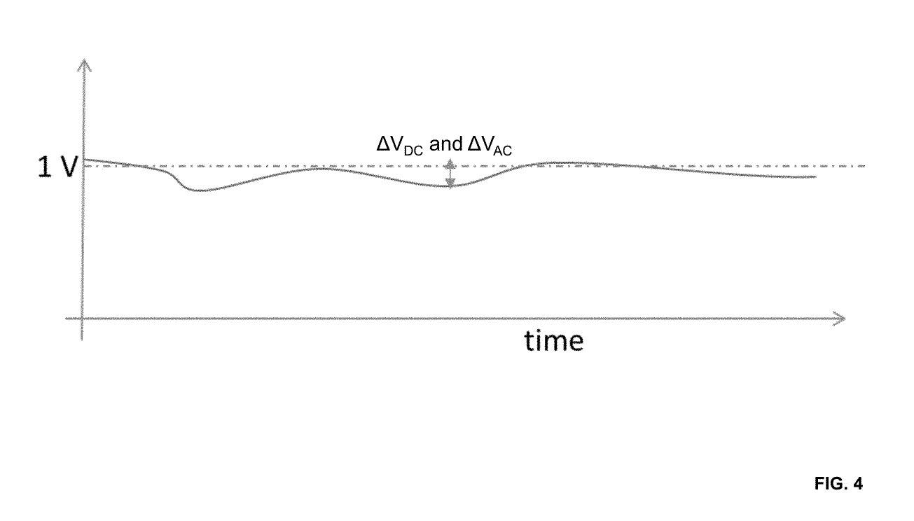

FIG. 4 illustrates a plot of a voltage supplied by a power distribution network (PDN) from a voltage regulator module (VRM) according to an exemplary embodiment of the present disclosure. The tolerance of a VRM is the measure of the stability or quality of the voltage supplied by the VRM to the PDN. VRMs with smaller tolerances are more costly to implement than VRMs with larger tolerances. For a voltage supplied by a VRM, V_{supply}, of 1.0 V, the DC and AC variation (tolerance) is shown as ΔV_{DC} and ΔV_{AC}.

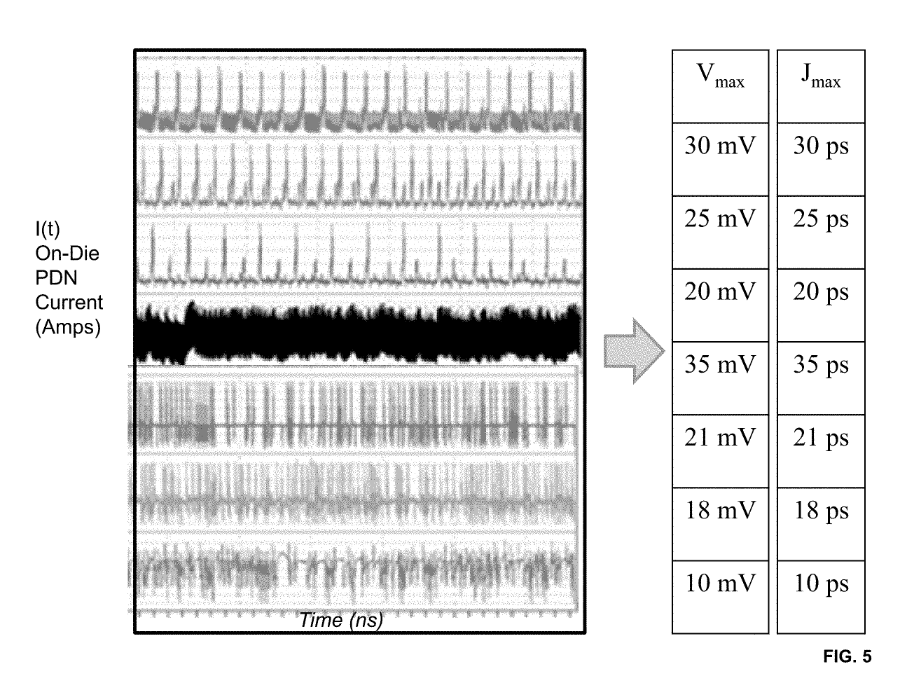

FIG. 5 illustrates on-die power distribution network (PDN) current waveforms, and on-die maximum PDN noise and jitter according to an exemplary embodiment of the present disclosure. Each of the on-die PDN current waveforms illustrated on the left side of FIG. 5 may represent a current waveform associated with a different operation performed by a component or different components in a system supported by the PDN. The on-die maximum PDN noise and jitter expected for each on-die PDN current waveform is illustrated on the right side of FIG. 5.

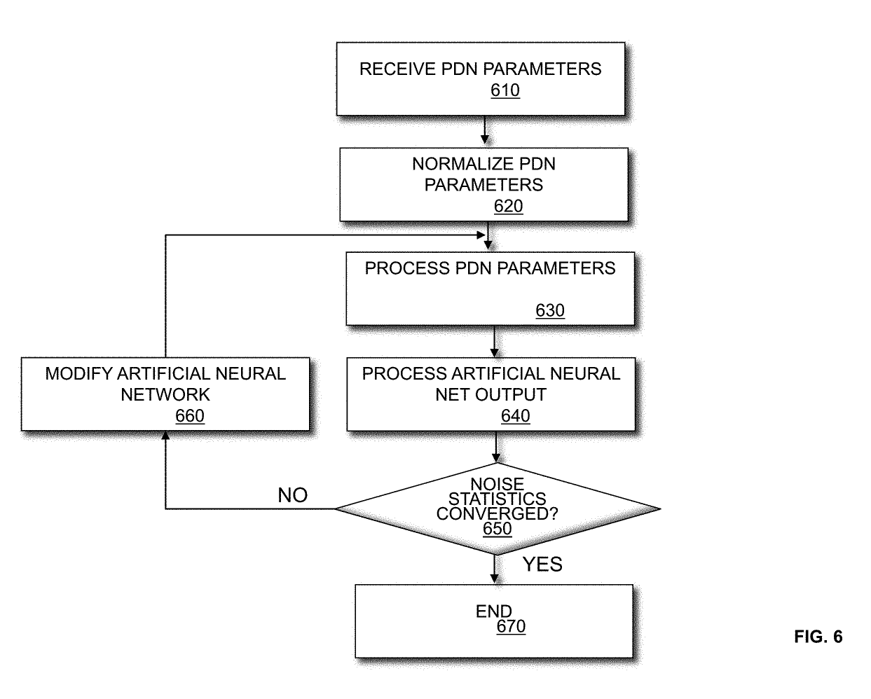

FIG. 6 is a flow chart illustrating a method for training an artificial neural network to design a power distribution network (PDN) for a system according to an exemplary embodiment of the present disclosure. The procedures described in FIG. 6 may be used to implement procedure 110 shown in FIG. 1. At 610, PDN parameters are received. The PDN parameters received include PDN parameters that are input into an artificial neural network to train the artificial neural network. These PDN parameters may include on-die PDN current, I(t), impedance of the PDN, Z_{PDN}, which includes the impedance of the board, Z_{Brd}, package, Z_{Pkg}, and integrated circuit, Z_{Die}. and voltage supplied by the VRM, V_{supply}, and its DC and AC tolerances, VRM_{DC} and VRM_{AC}. The PDN parameters received may also include PDN parameters that are not input into the artificial neural network, but are used to compare with outputs of the artificial neural network to determine how to modify the artificial neural network. These PDN parameters may include expected signal variation statistics that may include noise and/or jitter statistics of the system, such as on-die maximum PDN noise, Vₘₐₓ, and on-die maximum jitter, Jₘₐₓ.

According to an embodiment of the present disclosure, the on-die PDN current used to train the artificial neural network may be in the format of a large library of current profiles from various modes of operation. The current waveforms as well as the maximum noise and/or jitter may correspond to an integrated circuit component in the system and may be collected during the design and testing of the integrated circuit component. A specific integrated circuit component may be used with one or more package designs. Therefore, the properties of various packages are also used in the training of the artificial neural network. Embodiments of the present disclosure train an artificial neural network with a large number of current profiles that covers various modes of operation of each integrated circuit component.

At 620, the PDN parameters are normalized. Normalization may be performed on some of the PDN parameters to ensure that the PDN parameters are compatible with each other with respect to domain, magnitude, and/or dimension. For example, according to an embodiment of the present disclosure, transformations are performed on PDN parameters, such as the impedance of the PDN, to transform values in a frequency domain to values in a time domain. This would allow values for the impedance of the PDN to be compatible with values of the on-die PDN current waveform which are in the time domain. According to an alternate embodiment of the present disclosure, transformations are performed on PDN parameters, such as the on-die PDN current waveform, to transform values in a time domain to values in a frequency domain. This would allow values for the impedance of the PDN to be compatible with values of the on-die PDN current waveform which are in the time domain. It should be appreciated that the transformations performed may be a Fast Fourier Transform or an Inverse Fast Fourier Transform. According to an embodiment of the present disclosure, when expected values for both on-die maximum noise and on-die maximum jitter are used for training, values for on-die maximum noise and on-die maximum jitter may be normalized to reduce bias.

At 630, the PDN parameters are processed by the artificial neural network. According to an embodiment of the present disclosure, on-die PDN current, I(t), impedance of the PDN, Z_{PDN}, which includes the impedance of the board, Z_{Brd}, package, Z_{Pkg}, and integrated circuit, Z_{Die}. and voltage supplied by the VRM, V_{supply}, and its DC and AC tolerances, VRM_{DC} and VRM_{AC}, are input into the artificial neural network. The output of the artificial neural network may include noise and/or jitter statistics which include the on-die maximum PDN noise, Vₘₐₓ, and/or on-die maximum jitter, Jₘₐₓ.

At 640, the output of the artificial neural network is processed. According to an embodiment of the present disclosure, the noise and/or jitter statistics generated by the artificial neural network is compared with expected noise and/or jitter statistics received at 610.

At 650, if it is determined that the noise and/or jitter statistics output from the artificial neural network does not match or converge to the values of the expected noise and/or jitter statistics, control proceeds to 660. If it is determined that the noise and/or jitter statistics output from the artificial neural network match or converge to the values of the expected noise and/or jitter statistics, control proceeds to 670.

At 660, the artificial neural network is modified such that the noise and/or jitter statistics generated by a modified neural network match the expected noise and/or jitter statistics of the system. According to an embodiment of the present disclosure, the modification of the artificial neural network is performed by training the artificial neural network using backpropagation techniques. The modifications may be made over a series of iterations of modifications at 660, subsequent processing of PDN parameters with the modified artificial neural network at 630, processing of the output of the artificial neural network 640, and convergence checking at 650.

At 670, control terminates the procedure.

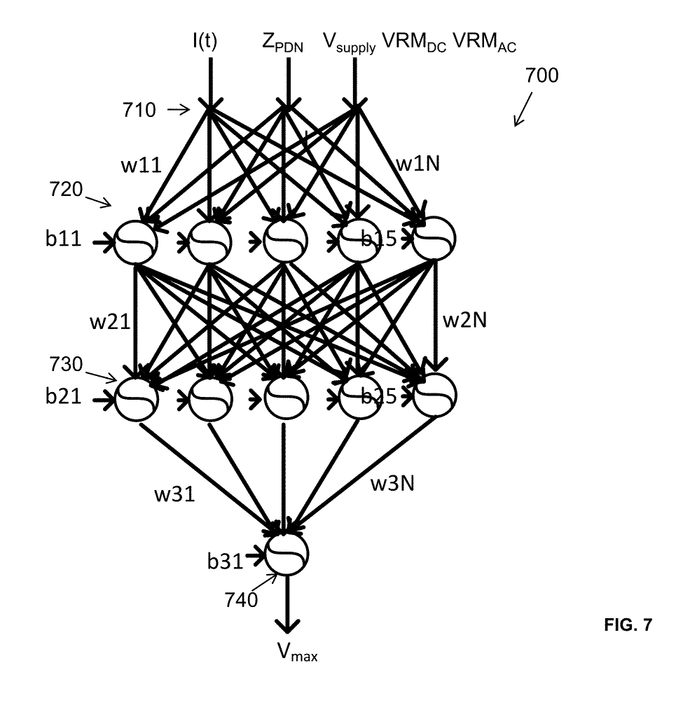

FIG. 7 illustrates an artificial neural network according to an exemplary embodiment of the present disclosure. The artificial neural network 700 includes an input layer 710, hidden layers 720 and 730, and an output layer 740. The hidden layers 720 and 730 include 5 nodes. The output layer 740 includes a single node. The path to and from each node includes a weight. The paths between the input layer 710 and hidden layer 720 have weights w11 to w1N. The paths between hidden layer 720 and hidden layer 730 have weights w21 to w2N. The paths between hidden layer 730 and output layer 740 have weights w31 to w3N. Each node has a bias value. The nodes in hidden layer 720 have bias values b11 to b15. The nodes in hidden layer 730 have bias values b21 to b25. The node in output layer 740 has bias value b31. As shown, the inputs to the artificial neural network 700 include PDN parameters, on-die PDN current, I(t), impedance of the PDN, Z_{PDN}, which includes the impedance of the board, Z_{Brd}, package, Z_{Pkg}, and integrated circuit, Z_{Die}. and voltage supplied by the VRM, V_{supply}, and its DC and AC tolerances, VRM_{DC} and VRM_{AC}. The output of the artificial neural network 700 is the on-die maximum PDN noise value, Vₘₐₓ.

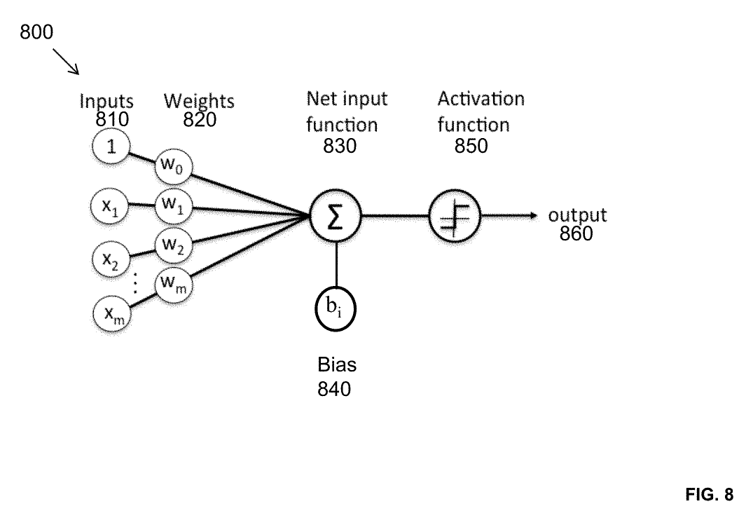

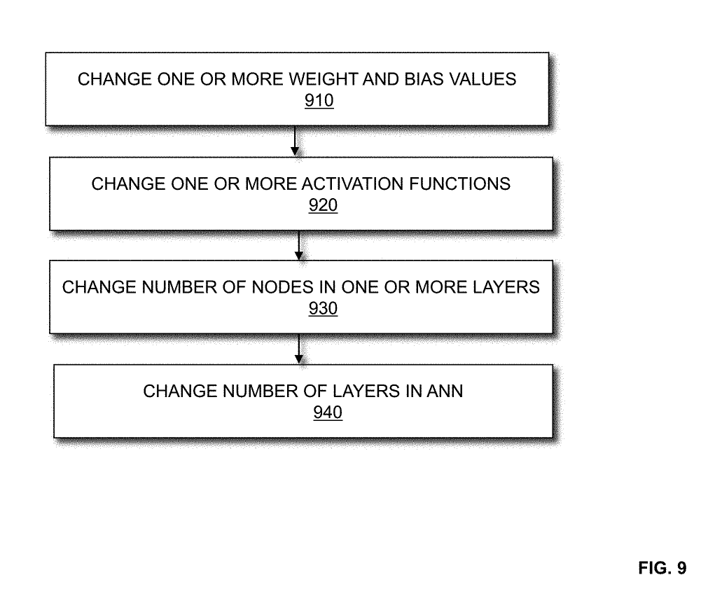

FIG. 8 illustrates a node 800 in an artificial neural network according to an exemplary embodiment of the present disclosure. The node 800 may be used to implement one of the nodes illustrated in FIG. 9. The node 800 includes a plurality of inputs 810. Each of the inputs may have one of the weights 820 applied to its value. A net input function 830 sums the weighted inputs and applies a bias value 840, bᵢ, to the sum. An activation function 850 is applied to the output of the net input function 830 to generate output 860. It should be appreciated that the activation function may be implemented by a linear step, sigmoid, hyperbolic tangent, or other type of function.

Referring back to FIG. 6, when training the artificial neural network, the weight and bias values of the artificial neural network are initialized with random values. During training, the artificial neural network is modified by adjusting the weight and bias values so that the output of the artificial neural network and the expected results match or converge. If the output of the artificial neural network and the expected results do not match, further modifications may be made to the artificial neural network by modifying the architecture of the artificial neural network by changing the number of nodes, connections, and/or layers in the artificial neural network, and/or the activation functions in the nodes. It should be appreciated that various algorithms, including gradient-based algorithms may be employed to modify the artificial neural network during training For example, backpropagation is one method that may be used to compute a gradient for the calculation of weights to be used in the artificial neural network.

FIG. 9 is a flow chart illustrating a method for modifying an artificial neural network according to an exemplary embodiment of the present disclosure. The procedures described in FIG. 9 may be used to implement procedure 660 shown in FIG. 6. At 910, one or more weight and bias values in the artificial neural network is changed.

At 920, one or more activation functions in the artificial neural network is changed.

At 930, the number of nodes and connections in one or more layers of the artificial neural network are changed.

At 940, a number of layers in the artificial neural network is changed.

It should be appreciated that all of the procedures described in FIG. 9 may be performed during a single iteration of procedure 660. Alternatively, one or more of the procedures described in FIG. 9 may be performed at a separate iteration of procedure 660 when modifying the artificial neural network. In one embodiment, procedure 910 is performed during a first iteration of procedure 660. In response to determining that the output of the modified artificial neural network does not converge with expected results, one or more of procedures 920, 930, and 940 is performed on the artificial neural network to modify the architecture of the artificial neural network during a second iteration of procedure 660. According to an embodiment of the present disclosure, each procedure illustrated in FIG. 9 is performed alone at a separate iteration of procedure 660.

After the artificial neural network is trained, a designer may use the trained artificial neural network to design the boards and VRMs for the PDN in the system. The designer's board impedance value may replace the original board impedance value that was used for training the artificial neural network. The voltage supplied by the PDN from the designer's VRM and its tolerances may replace the original voltage and tolerance values used for training the artificial neural network. If the signal variation statistics for the PDN, such as the noise and/or jitter statistics for the PDN, are not acceptable, the design of the board and/or the selection of the VRM and its tolerances may be modified.

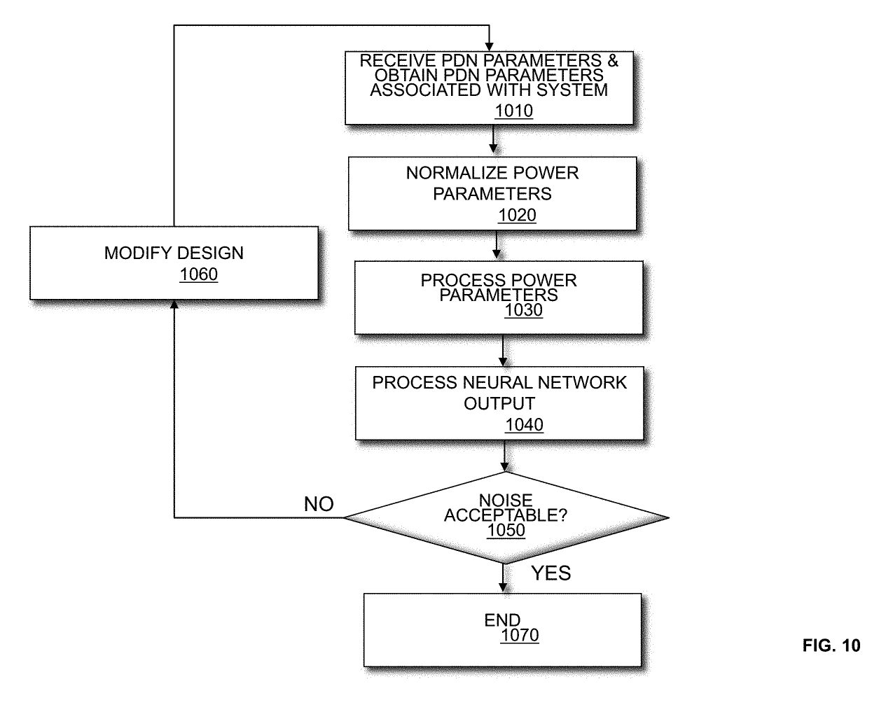

FIG. 10 is a flow chart illustrating a method for designing a power distribution network (PDN) on a system using a trained artificial neural network according to an exemplary embodiment of the present disclosure. The procedures described in FIG. 10 may be used to implement procedure 120 shown in FIG. 1. At 1010, PDN parameters are received. According to an embodiment of the present disclosure, the PDN parameters received are related to the system and are provided by a designer of the system. These PDN parameters may include the impedance of the PDN associated with a board to be implemented by the system, Z_{Brd}, and voltage supplied by the PDN from the VRM to be implemented by the system, V_{supply}, and its DC and AC tolerances, VRM_{DC} and VRM_{AC}.

Additional information may also be received from the designer of the system such as the type and properties of packages and integrated circuit components to be implemented on the system, and the activities and functionalities to be performed by the integrated circuit components. From the additional information, specific PDN parameters associated with the system may be obtained. For example specific on-die PDN current, I(t), impedance of the package, Z_{Pkg}, and impedance of the integrated circuit, Z_{Die}, associated with the type and properties of packages and integrated circuit components to be implemented on the system, and the activities and functionalities to be performed by the integrated circuit components may be retrieved and used to evaluate the PDN.

At 1020, the PDN parameters are normalized. Normalization may be performed on some of the PDN parameters to ensure that the PDN parameters are compatible with each other with respect to domain, magnitude, and/or dimension.

At 1030, the PDN parameters are processed by the trained artificial neural network. According to an embodiment of the present disclosure, on-die PDN current, I(t), impedance of the PDN, Z_{PDN}, which includes the impedance of the board, Z_{Brd}, package, Z_{Pkg}, and integrated circuit, Z_{Die}. and voltage supplied by the VRM, V_{supply}, and its DC and AC tolerances, VRM_{DC} and VRM_{AC}, are input into the trained artificial neural network. The output of the artificial neural network is signal variation statistics that may include noise and/or jitter statistics such as the on-die maximum PDN noise, Vₘₐₓ, and/or on-die maximum jitter, Jₘₐₓ.

At 1040, the output of the trained artificial neural network is processed. According to an embodiment of the present disclosure, when a plurality of values are output by the trained artificial neural network for the on-die maximum PDN noise and/or the on-die maximum jitter, a maximum value is identified for each. The noise and/or jitter statistics generated by the trained artificial neural network are compared with acceptable noise and/or jitter statistics value for the system. The acceptable noise and/or jitter statistics may include values identified by the designer of the system.

At 1050, if it is determined that the noise and/or jitter statistics output from the trained artificial neural network are not acceptable, control proceeds to 1060. If it is determined that the noise and/or jitter statistics output from the trained artificial neural network are acceptable, control proceeds to 1070.

At 1060, the design for the PDN of the system is modified such that the noise and/or jitter statistics generated by the modified PDN of the system are acceptable. The modifications may be made over a series of iterations of modifications at 1060. According to an embodiment of the present disclosure, the modifications at 1060 may include modifying the PDN impedance associated with the board to be implemented by the system, Z_{Brd}, and voltage supplied by the PDN from the VRM to be implemented by the system, V_{supply}, and its DC and AC tolerances, VRM_{DC} and VRM_{AC}.

At 1070, control terminates the procedure.

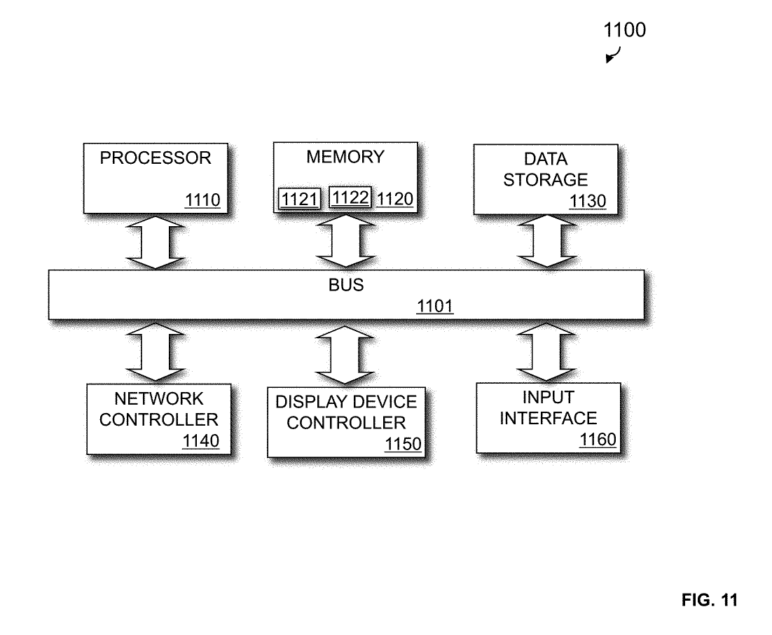

FIG. 11 illustrates a block diagram of a computer system 1100 implementing an artificial neural network training unit 1121 and a power distribution network (PDN) design unit according to an exemplary embodiment of the present disclosure. The computer system 1100 includes a processor 1110 that process data signals. The processor 1110 is coupled to a bus 1101 or other switch fabric that transmits data signals between processor 1110 and other components in the computer system 1100. The computer system 1100 includes a memory 1120. The memory 1120 may store instructions and code represented by data signals that may be executed by the processor 1110. A data storage device 1130 is also coupled to the bus 1101.

A network controller 1140 is coupled to the bus 1101. The network controller 1140 may link the computer system 1100 to a network of computers (not shown) and supports communication among the machines. A display device controller 1150 is coupled to the bus 1101. The display device controller 1150 allows coupling of a display device (not shown) to the computer system 1100 and acts as an interface between the display device and the computer system 1100. An input interface 1160 is coupled to the bus 1101. The input interface 1160 allows coupling of an input device (not shown) to the computer system 1100 and transmits data signals from the input device to the computer system 1100.

An artificial neural network training unit 1121 and a PDN design unit 1122 are stored in memory 1120 and executed by the processor 1110. The artificial neural network training unit 1121 trains an artificial neural network to design a PDN for a system. According to an embodiment of the present disclosure, a supervised training methodology is employed where the artificial neural network is evaluated and modified in response to desired or expected output values provided. According to an aspect of this embodiment, the artificial neural network is trained to capture the behavior of the system using PDN parameters that include a large database of PDN current waveforms, corresponding PDN noise waveforms, voltage regulator module (VRM) tolerances, and impedance of the PDN associated with the board, packages, and integrated circuits in the system.

The PDN design unit 1122 evaluates inputted PDN parameters for the PDN for a system in response to signal variation statistics such as noise and/or jitter statistics output from the trained artificial neural network. The inputted PDN parameters may be iteratively modified during this design phase until the noise and/or jitter statistics output from the trained artificial neural network are acceptable. It should be appreciated that the PDN parameters provided by a user or designer during the design phase is a proper subset of the PDN parameters used by the artificial neural network during training. According to an embodiment of the present disclosure, the PDN design unit 1122 evaluates the impedance of the PDN associated with a board in the system, and the voltage and voltage tolerance supplied by a voltage regulator module (VRM) of the PDN.

Although the artificial neural network training unit 1121 and the PDN design unit 1122 are described as being implemented on a single computer system 1100, it should be appreciated that they may be implemented on different computer systems. For example, training of the artificial neural network with the artificial neural network training unit 1121 may be performed by the manufacturer of the board, packages, and integrated circuit components of a system using a first computer system. The trained artificial neural network may later be used by a designer with the PDN design unit 1122 to design the PDN for the system using a second computer system.

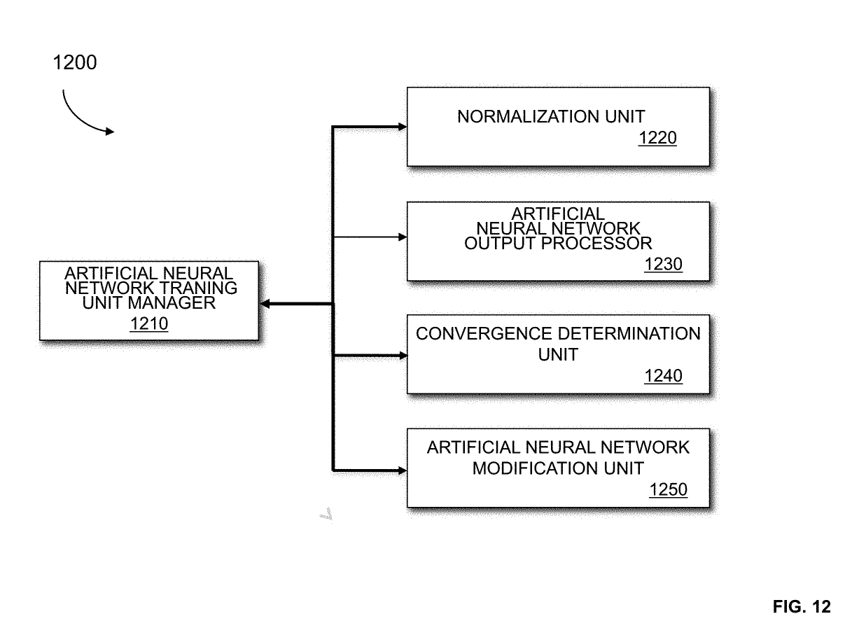

FIG. 12 is a block diagram of an artificial neural network training unit 1200 according to an exemplary embodiment of the present disclosure. FIG. 12 illustrates modules implementing an embodiment of the artificial neural network training unit 1200. According to one embodiment, the modules represent software modules and training of an artificial neural network may be performed by a computer system such as the one illustrated in FIG. 11 executing sequences of instructions represented by the modules shown in FIG. 12. Execution of the sequences of instructions causes the computer system to support system design as will be described hereafter. In alternate embodiments, hard-wire circuitry may be used in place of or in combination with software instructions to implement embodiments of present disclosure. Thus, embodiments of present disclosure are not limited to any specific combination of hardware circuitry and software.

The artificial neural network training unit 1200 includes an artificial neural network training unit manager 1210. The artificial neural network training unit manager 1210 is coupled to and transmits data to and between other components in the artificial neural network training unit 1200. The artificial neural network training unit manager 1210 also receives PDN parameters. The PDN parameters received include PDN parameters that are input into an artificial neural network to train the artificial neural network. These PDN parameters may include on-die PDN current, I(t), impedance of the PDN, Z_{PDN}, which includes the impedance of the board, Z_{Brd}, package, Z_{Pkg}, and integrated circuit, Z_{Die}. and voltage supplied by the VRM, V_{supply}, and its DC and AC tolerances, VRM_{DC} and VRM_{AC}. The PDN parameters received may also include PDN parameters that are not input into the artificial neural network, but are used to compare with outputs of the artificial neural network to determine how to modify the artificial neural network. These PDN parameters may include expected signal variation statistics that may include expected noise and/or jitter statistics of the system, such as on-die maximum PDN noise, Vₘₐₓ, and on-die maximum jitter, Jₘₐₓ.

The artificial neural network training unit 1200 includes a normalization unit 1220. The normalization unit 1220 normalizes the PDN parameters. Normalization may be performed on some of the PDN parameters to ensure that the PDN parameters are compatible with each other with respect to domain, magnitude, and/or dimension.

The artificial neural network training unit 1200 includes an artificial neural network output processor 1230. The artificial neural network output processor 1230 compares noise and/or jitter statistics generated by the artificial neural network with expected noise and/or jitter statistics.

The artificial neural network training unit 1200 includes a convergence determination unit 1240. The convergence determination unit 1240 determines whether the noise and/or jitter statistics output from the artificial neural network matches or converges to the values of the expected noise and/or jitter statistics.

The artificial neural network training unit 1200 includes an artificial neural network modification unit 1250. In response to a determination that the noise and/or jitter statistics output from the artificial neural network does not match or converge to the values of the expected noise and/or jitter statistics, the artificial neural network modification unit 1250 modifies the artificial neural network such that the noise and/or jitter statistics generated by a modified neural network matches the expected noise and/or jitter statistics of the system. The artificial neural network modification unit 1250 may modify the artificial neural network by changing one or more weight and bias values, one or more activation functions, a number of nodes and connections in one or more layers of the artificial neural network, and a number of layers in the artificial neural network. It should be appreciated that the artificial neural network training unit 1200 may perform the procedures described with reference to FIGS. 1, 6, and 9.

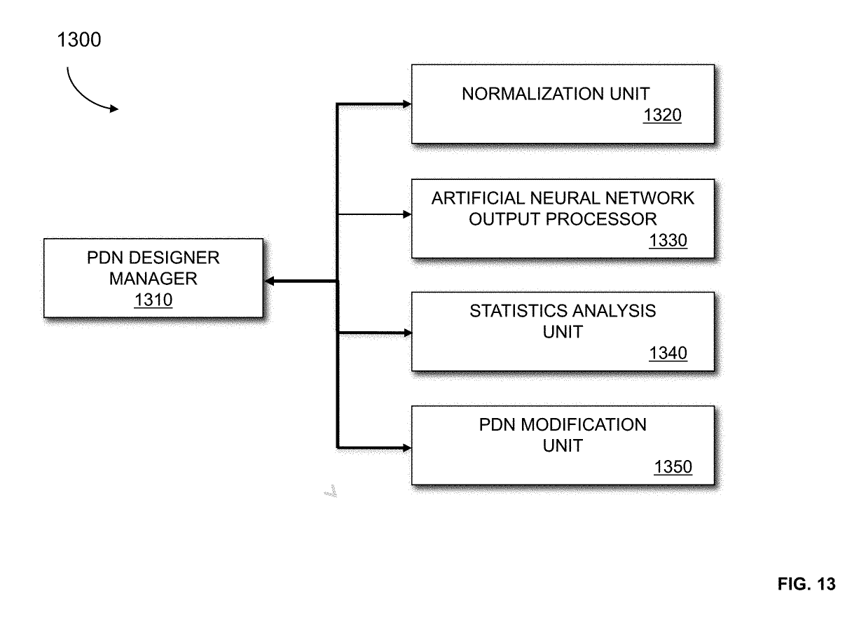

FIG. 13 is a block diagram of a power distribution network (PDN) design unit 1300 according to an exemplary embodiment of the present disclosure. FIG. 13 illustrates modules implementing an embodiment of the PDN design unit 1300. According to one embodiment, the modules represent software modules for designing a PDN for a system using a trained artificial neural network may be performed by a computer system such as the one illustrated in FIG. 11 executing sequences of instructions represented by the modules shown in FIG. 13. Execution of the sequences of instructions causes the computer system to support system design as will be described hereafter. In alternate embodiments, hard-wire circuitry may be used in place of or in combination with software instructions to implement embodiments of present disclosure. Thus, embodiments of present disclosure are not limited to any specific combination of hardware circuitry and software.

The PDN design unit 1300 includes a PDN designer manager 1310. The PDN designer manager 1310 is coupled to and transmits data to and between other components in the PDN design unit 1300. The PDN designer manager 1310 also receives PDN parameters. According to an embodiment of the present disclosure, the PDN parameters received are related to the system and are provided by a designer of the system. These PDN parameters may include the impedance of the PDN associated with a board to be implemented by the system, Z_{Brd}, and voltage supplied by the PDN from the VRM to be implemented by the system, V_{supply}, and its DC and AC tolerances, VRM_{DC} and VRM_{AC}. The PDN designer manager 1310 also receives additional information from the designer of the system such as the type and properties of packages and integrated circuit components to be implemented on the system, and the activities and functionalities to be performed by the integrated circuit components. From the additional information, specific PDN parameters associated with the system may be obtained. For example specific on-die PDN current, I(t), impedance of the package, Z_{Pkg}, and impedance of the integrated circuit, Z_{Die}, associated with the type and properties of packages and integrated circuit components to be implemented on the system, and the activities and functionalities to be performed by the integrated circuit components may be retrieved and used to evaluate the PDN.

The PDN design unit 1300 includes a normalization unit 1320. The normalization unit 1320 normalizes the PDN parameters. Normalization may be performed on some of the PDN parameters to ensure that the PDN parameters are compatible with each other with respect to domain, magnitude, and/or dimension.

The PDN design unit 1300 includes an artificial neural network output processor 1330. The artificial neural network output processor 1330 processes the output of the trained artificial neural network. According to an embodiment of the present disclosure, when a plurality of values are output by the trained artificial neural network for the on-die maximum PDN noise and/or the on-die maximum jitter, a maximum value is identified for each. The noise and/or jitter statistics generated by the trained artificial neural network are compared with acceptable noise and/or jitter statistics value for the system. The acceptable noise and/or jitter statistics may include values identified by the designer of the system.

The PDN design unit 1300 includes a statistics analysis unit 1340. The statistics analysis unit 1340 determines whether the noise and/or jitter statistics output from the trained artificial neural network are acceptable.

The PDN design unit 1300 includes a PDN modification unit 1350. In response to a determination that the noise and/or jitter statistics output from the trained artificial neural network is not acceptable, the PDN modification unit 1350 modifies the design for the PDN of the system such that the noise and/or jitter statistics generated by the modified PDN of the system are acceptable. The modifications may be made over a series of iterations of modifications. According to an embodiment of the present disclosure, the modifications may include modifying the PDN impedance associated with the board to be implemented by the system, Z_{Brd}, and voltage supplied by the PDN from the VRM to be implemented by the system, V_{supply}, and its DC and AC tolerances, VRM_{DC} and VRM_{AC}. It should be appreciated that the PDN design unit 1300 may perform the procedures described with reference to FIGS. 1, 6, and 9.

FIGS. 1, 6, 9, and 10 are flow charts that illustrate embodiments of the present disclosure. The procedures described in these figures may be performed by a computer system. Some of the techniques illustrated may be performed sequentially, in parallel or in an order other than that which is described and that the procedures described may be repeated. It is appreciated that not all of the techniques described are required to be performed, that additional techniques may be added, and that some of the illustrated techniques may be substituted with other techniques.

It should be appreciated that embodiments of the present disclosure may be provided as a computer program product, or software, that may include a computer-readable or machine-readable medium having instructions. The instructions on the computer-readable or machine-readable medium may be used to program a computer system or other electronic device. The machine-readable medium may include, but is not limited to, floppy diskettes, optical disks, CD-ROMs, and magneto-optical disks or other type of media/machine-readable medium suitable for storing electronic instructions including those used for cloud computing. The techniques described herein are not limited to any particular software configuration. They may find applicability in any computing or processing environment. The terms “computer-readable medium” or “machine-readable medium” used herein shall include any medium that is capable of storing or encoding a sequence of instructions for execution by the computer and that cause the computer to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

The following examples pertain to further embodiments. In one embodiment, a method for training an artificial neural network to design a power distribution network (PDN) for a system includes generating signal variation statistics of the system from PDN parameters input into the artificial neural network. The artificial neural network is modified such that the signal variation statistics of the system generated by the neural network match expected signal variation statistics of the system.

In a further embodiment, the method wherein the PDN parameters comprises PDN current waveforms, voltage supplied by the PDN and AC and DC tolerance of the voltage supplied, and impedance of the PDN for the system.

In a further embodiment, the method wherein the impedance of the PDN for the system includes the impedance of the PDN associated with a board, package, and die of the system.

In a further embodiment, the method further comprising transforming the PDN current waveforms from a time domain to a frequency domain before inputting the PDN current waveforms into the artificial neural network.

In a further embodiment, the method further comprising transforming the impedance of the PDN for the system from a frequency domain to a time domain before inputting the impedance of the PDN into the artificial neural network.

In a further embodiment, the method wherein the signal variation statistics comprise one of on-die maximum PDN noise and on-die maximum jitter.

In a further embodiment, the method wherein the signal variation statistics comprise on-die maximum PDN noise and on-die maximum jitter.

In a further embodiment, the method further comprising normalizing the on-die maximum PDN noise and the on-die maximum jitter to reduce bias during the training

In a further embodiment, the method further comprising initializing weight and bias values in the artificial neural network.

In a further embodiment, the method wherein modifying the artificial neural network comprises changing weight and bias values.

In a further embodiment, the method wherein modifying the artificial neural network comprises changing an activation function in a node.

In a further embodiment, the method wherein modifying the artificial neural network comprises changing a number of nodes in a layer of the neural network.

In a further embodiment, the method wherein modifying the artificial neural network comprises changing a number of layers in the neural network.

In a further embodiment, a method for designing a power distribution network (PDN) for a system includes generating signal variation statistics of the system from PDN parameters input into a trained artificial neural network by a designer. The PDN parameters are modified such that the signal variation statistics of the system generated by the trained artificial neural network satisfy requirements of the system.

In a further embodiment, the method wherein the PDN parameters comprise voltage supplied by the PDN and AC and DC tolerance of the voltage supplied, and impedance of the PDN associated with a board.

In a further embodiment, the method wherein the signal variation statistics comprise at least one of on-die maximum PDN noise and on-die maximum jitter.

In a further embodiment, the method wherein modifying the PDN parameters comprises changing an impedance of the PDN associated with a board.

In a further embodiment, the method wherein modifying the PDN parameters comprises changing a voltage supplied by the PDN and AC and DC tolerance of the voltage supplied.

In a further embodiment, the method wherein the PDN parameters input into the trained artificial neural network by the designer are a proper subset of PDN parameters used for training the trained artificial neural network.

In a further embodiment, the method a non-transitory computer readable medium including a sequence of instructions stored thereon for causing a computer to execute a method for designing a power distribution network (PDN) for a system includes generating signal variation statistics of the system from PDN parameters input into a trained artificial neural network by a designer. The PDN parameters are modified such that the signal variation statistics of the system generated by the trained artificial neural network satisfy requirements of the system.

In a further embodiment, the non-transitory computer readable medium wherein the PDN parameters comprise voltage supplied by the PDN and AC and DC tolerance of the voltage supplied, and impedance of the PDN associated with a board.

In a further embodiment, the non-transitory computer readable medium wherein the signal variation statistics comprise at least one of on-die maximum PDN noise and on-die maximum jitter.

In a further embodiment, the non-transitory computer readable medium wherein modifying the PDN parameters comprises changing an impedance of the PDN associated with a board.

In the foregoing specification, embodiments of the disclosure have been described with reference to specific exemplary embodiments thereof. It will, however, be evident that various modifications and changes may be made thereto without departing from the broader spirit and scope of the embodiments of the disclosure. The specification and drawings are, accordingly, to be regarded in an illustrative rather than restrictive sense.

What is claimed is:

1. A method for training an artificial neural network to design a power distribution network (PDN) for a system, comprising:
generating signal variation statistics of the system from PDN parameters input into the artificial neural network; and
modifying the artificial neural network such that the signal variation statistics of the system generated by the neural network match expected signal variation statistics of the system.

2. The method of claim 1, wherein the PDN parameters comprises PDN current waveforms, voltage supplied by the PDN and AC and DC tolerance of the voltage supplied, and impedance of the PDN for the system.

3. The method of claim 2, wherein the impedance of the PDN for the system includes the impedance of the PDN associated with a board, package, and die of the system.

4. The method of claim 2 further comprising transforming the PDN current waveforms from a time domain to a frequency domain before inputting the PDN current waveforms into the artificial neural network.

5. The method of claim 2 further comprising transforming the impedance of the PDN for the system from a frequency domain to a time domain before inputting the impedance of the PDN into the artificial neural network.

6. The method of claim 1, wherein the signal variation statistics comprise one of on-die maximum PDN noise and on-die maximum jitter.

7. The method of claim 1, wherein the signal variation statistics comprise on-die maximum PDN noise and on-die maximum jitter.

8. The method of claim 7 further comprising normalizing the on-die maximum PDN noise and the on-die maximum jitter to reduce bias during the training.

9. The method of claim 1 further comprising initializing weight and bias values in the artificial neural network.

10. The method of claim 1, wherein modifying the artificial neural network comprises changing weight and bias values.

11. The method of claim 1, wherein modifying the artificial neural network comprises changing an activation function in a node.

12. The method of claim 1, wherein modifying the artificial neural network comprises changing a number of nodes in a layer of the neural network.

13. The method of claim 1, wherein modifying the artificial neural network comprises changing a number of layers in the neural network.

14. A method for designing a power distribution network (PDN) for a system, comprising:
generating signal variation statistics of the system from PDN parameters input into a trained artificial neural network by a designer; and
modifying the PDN parameters such that the signal variation statistics of the system generated by the trained artificial neural network satisfy requirements of the system.

15. The method of claim 14, wherein the PDN parameters comprise voltage supplied by the PDN and AC and DC tolerance of the voltage supplied, and impedance of the PDN associated with a board.

16. The method of claim 14, wherein the signal variation statistics comprise at least one of on-die maximum PDN noise and on-die maximum jitter.

17. The method of claim 14, wherein modifying the PDN parameters comprises changing an impedance of the PDN associated with a board.

18. The method of claim 14, wherein modifying the PDN parameters comprises changing a voltage supplied by the PDN and AC and DC tolerance of the voltage supplied.

19. The method of claim 14, wherein the PDN parameters input into the trained artificial neural network by the designer are a proper subset of PDN parameters used for training the trained artificial neural network.

20. A non-transitory computer readable medium including a sequence of instructions stored thereon for causing a computer to execute a method for designing a power distribution network (PDN) for a system, comprising:
generating signal variation statistics of the system from PDN parameters input into a trained artificial neural network by a designer; and
modifying the PDN parameters such that the signal variation statistics of the system generated by the trained artificial neural network satisfy requirements of the system

21. The non-transitory computer readable medium of claim 20, wherein the PDN parameters comprise voltage supplied by the PDN and AC and DC tolerance of the voltage supplied, and impedance of the PDN associated with a board.

22. The non-transitory computer readable medium of claim 20, wherein the signal variation statistics comprise at least one of on-die maximum PDN noise and on-die maximum jitter.

23. The non-transitory computer readable medium of claim 20, wherein modifying the PDN parameters comprises changing an impedance of the PDN associated with a board.
